(19) United States
(12) Patent Application Publication
(10) Pub. No.: US 2009/0260398 A1
(43) Pub. Date: Oct. 22, 2009

(54) METHOD AND DEVICE FOR PRODUCING GLASS PIPETTES OR GLASS CAPILLARIES

(75) Inventor: Albrecht Lepple-Wienhues, Tübingen (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Flyion GmbH, Tubingen (DE)

(21) Appl. No.: 12/293,834

(22) PCT Filed: Mar. 23, 2007
(86) PCT No.: PCT/EP07/02586

§ 371 Date: Oct. 23, 2008

(30) Foreign Application Priority Data
Mar. 23, 2006 (DE) 10 2006 014 512.7

(51) Int. Cl. C03B 23/043; C03B 29/00

(52) U.S. Cl. 65/108; 65/162

(57) ABSTRACT

The invention relates to a method for producing glass pipettes or glass capillaries. In said method, a pipette or capillary (1) with a conical tip and a tubular section that adjoins the latter is fixed in a retaining device (2), the fixed glass pipene (1) is then introduced into the thermal radiation field of a heating unit (3), the glass pipette is softened at least in the tip region, a gas pressure is applied to the interior of the glass pipette in such a way that the diameter of said pipette is abruptly lengthened by a small amount between the base surface of the cone and the tubular section, the expanded glass pipette (1) is then removed from the thermal radiation field of the heating unit (3) and the abrupt lengthening of the diameter of the glass pipette (1) is verified and preferably controlled with the aid of an optical observation unit (4). The invention also relates to a corresponding device for the production of glass pipettes or glass capillaries (1) consisting of a retaining device, a heating unit, a positioning device, a pressure application unit, an observation unit and a control and verification unit.

The invention relates to a method of producing glass pipettes or glass capillaries and to an apparatus for producing glass pipettes or glass capillaries. The pipettes or capillaries here are provided, in particular, for carrying out patch-clamp experiments.

The interior of living cells is known to be enclosed by a lipid membrane which closes off the processes in the interior of the cell from the exterior surroundings. These lipid membranes are largely impermeable to charged particles. For this purpose, special transport proteins which are incorporated in the membranes perform the task of transporting the charged particles (ions) through the membrane. These transport proteins therefore form the basis for a large number of physiological functions.

Cytobiological research was revolutionized by the so-called patch-clamp method, which was developed by Sakmann and Neher in 1981. The patch-clamp technique allows the direct measurement, with high time resolution, of currents which are produced by the ion transporters in the membrane. The resulting advantages are known. It is thus possible to establish directly, for example, the effect of signal molecules or pharmacologically active substances on a target protein. Moreover, the patch-clamp technique makes it possible to monitor the electrical and chemical environment of a membrane in precise terms and also makes it possible to use signal molecules, pharmacologically active substances, etc. on both sides of a membrane.

In view of the fact that the patch-clamp technique is known, and frequently used, by a person skilled in the art, there is no need to discuss the basics of this in any more detail.

It is conventional procedure in the patch-clamp technique for a glass capillary or glass (micro-) pipette to be moved mechanically into the vicinity of a cell, and thus of the cell membrane of the latter, and to be fixed there by suction. This leads to an electrically tight connection between the cell membrane and the tip of the pipette. This electrically tight connection is a prerequisite for high-resolution low-noise measurement of small and very small currents. The electrically tight connection is often also referred to as a “seal”. In order to carry out reasonable patch-clamp measurements, it is necessary to have a so-called “gigaseal”, i.e. an electrically tight connection in which the electrical resistance reaches the gigaohm range. Resistances of 10 gigaohms and above are usually required in order to ensure that even small ions such as protons do not pass through in an uncontrolled manner between the cell membrane and glass surface.

The abovedescribed patch-clamp technique with the glass pipette coming into contact with the cell membrane “from the outside” has advantageously been modified in the past by the cell or corresponding biological structure being introduced into the interior of a glass capillary or glass (micro-) pipette. In respect of the precise procedure, reference is made here to WO 02/10747 A2. The resulting advantages can likewise be found in this laid-open application.

The glass pipettes or glass capillaries which are used for patch-clamp experiments in the prior art usually have a conical tip and an essentially tubular section adjoining this tip. Such pipettes or capillaries are usually produced by conventional glass-blowing techniques, namely by the drawing (pulling) of glass tubes following or during the operation of melting the region in which the conical narrowing and tip is to be produced. Such pipettes or capillaries with a conical tip are then used both for those techniques in which the glass capillary is guided up to the cell membrane from the outside and for those techniques in which the cell is fixed in the interior of the capillary, with a gigaseal being formed.

In the case of the last-mentioned techniques (fixing of the cell in the interior of the capillary), difficulties may arise if it is necessary, in the interior of the capillary, for the solutions contained therein to be exchanged, in particular quickly. As has been mentioned, patch-clamp experiments are often used to investigate the interaction of the membrane proteins and/or of the interior of the cell with active substances, or active-substance candidates, which are moved up to the membrane from the outside. This movement of the corresponding substances up to the membrane should take place, in principle, as quickly as possible. In the case of chemically controlled operations on the membrane, it is frequently the case that this is even imperative.

Their shape and geometry mean that the prior-art pipettes and capillaries are less than optimum for such a quick changeover of solutions and/or for moving active substances, or active-substance candidates, quickly up to the cell membrane. In patch-clamp techniques in which the cell is fixed in the interior of the capillary, the desire has been to provide the narrowest possible form of capillary, or of cone, at least at the fixing location.

Miriam B. Goodman and Shawn R. Lockery's publication (Journal of Neuroscience Methods 100 (2000), pages 13 to 15) does indeed disclose the practice of processing the tips of pipettes using so-called “pressure polishing”. In this publication, the tip of a conventional capillary or pipette is widened with the aid of gas pressure. For this purpose, a V-shaped filament, which acts as a punctiform heating source, has its tip directed onto the tip of the glass pipette. The essentially spherical thermal-radiation field generated melts and widens only the immediate tip of the pipette. The resulting widened section of the cone of the pipette thus achieves, at most, a diameter of approximately 30 to 35 μm, and is therefore not suitable for use in techniques which fix the cell in the interior of the capillary/pipette. Accordingly the abovementioned publication is also concerned exclusively with the conventional patch-clamp techniques in which the glass capillary is guided up to the membrane of a cell from the outside.

Accordingly, it is an object of the invention to provide a novel method which can be used to produce glass pipettes or glass capillaries. In particular, it is intended that the invention should provide novel pipettes or capillaries which can advantageously be used in patch-clamp techniques in which the cell or a corresponding biological structure is fixed in the interior of the capillary, with a gigaseal being formed in the process.

It is also an object of the invention to develop an apparatus for providing such pipettes or capillaries, in particular an apparatus for implementing the novel method.

This object is achieved by the method having the features of claim 1 and by the apparatus according to the features of claim 10. Preferred embodiments of the method according to the invention and of the apparatus according to the invention are defined in dependent claims 2 to 9 and 11 to 20, respectively. The wording of all the claims is thus included, by way of reference, in this description.

The method according to the invention of producing glass pipettes or glass capillaries which are provided, in particular, for patch-clamp experiments comprises the following method steps:
First of all, a glass pipette or glass capillary, which has a conical tip and an essentially tubular section adjoining the tip, is fixed in a retaining device.
The fixed glass pipette is introduced into the thermal-radiation field of a heating device. This preferably takes place such that the fixed glass pipette is moved into the thermal-radiation field of the heating device with the aid of a positioning device.
The glass pipette is softened, in particular melted, at least in the region of the tip, in particular in the region of the base surface of the cone and, if appropriate, also in that part of the tubular section which adjoins the tip. This softening operation preferably takes place in sections.
Prior to the softening operation and/or in the softened state, the interior of the glass pipette, and thus also the softened region of the latter, is subjected to a gas pressure. As a result, the diameter of the pipette between the base surface of the cone and the tubular section of the glass pipette widens abruptly to a larger diameter than that at the base surface. Abruptly is intended to mean here that the enlargement/widening of the diameter takes place over a short length, in particular over a length of less than 150 μm. The diameter here should preferably be widened in particular from a value of less than 50 μm at the base surface to a diameter of at least 100 μm in the tubular section of the glass pipette.
The glass pipette widened in this way is removed again from the thermal-radiation field of the heating device, the glass pipette preferably being moved out of the thermal-radiation field with the aid of the positioning device.
Finally, the method according to the invention is configured such that the abrupt widening of the diameter of the glass pipette is monitored and preferably also controlled with the aid of an optical observation device.

The following should also be noted by way of explanation.

As is known, a cone is a structure of conical or frustoconical shape. Accordingly, in the case of the invention, the pipette/capillary has a tip in the form of such a cone. As a result of its production process (usually drawing/pulling from a capillary), this tip is not exactly conical in geometrical terms, but can essentially be described as being of such a cone shape. Since the tip is necessarily open, i.e. is not closed, the cone is usually, for the purposes of the invention, in the form of a truncated cone.

A truncated cone is a body of rotation which is produced by a straight circular cone having a smaller cone cut off from it parallel to the base surface. This produces two parallel circular surfaces, of which the larger one is referred to as the base surface and the smaller one is referred to as the top surface. If this is applied, in turn, to the case of the present invention, then here in the case of the pipette/capillary the cone of the tip has its (larger) base surface adjoining the tubular section.

The method claimed by the invention has the advantage that, in comparison with the prior art, it is possible to achieve a significantly more pronounced, abrupt widening of the diameter of the capillary/pipette, to be precise starting from the location at which the cell, for the corresponding patch-clamp measurements, is fixed in the interior of the capillary/pipette, and extending to the larger-diameter tubular section of the capillary/pipette. This takes place according to the invention by much of the pipette being increased in diameter, preferably by various sections being melted and widened one after the other. In particular the section-by-section procedure makes it possible to achieve the desired widened contour of the pipette over a length which is greater than the extent of the thermal-radiation field. Furthermore, the measure according to the invention of preferably providing a radial thermal-radiation field also contributes to the success of the way in which the method is conducted according to the invention.

The abovedescribed way in which the method is conducted has the further advantage that the increase in diameter which is desired for the glass pipettes and glass capillaries can be observed and, if appropriate, controlled in a defined manner with optical monitoring. This means that it is not the case that pipettes or capillaries which do not have the desired abrupt increase in diameter have to be checked and separated out during a high-outlay monitoring check once the pipettes/capillaries have already been produced; rather, this monitoring check can be carried out specifically during the production process itself. In this way, however, it is not just possible to separate out incorrectly produced pipettes or capillaries during production. It is also possible to adjust the shape of the pipettes and capillaries in a specific manner and to modify the same in accordance with the respective requirements. This allows largely automated production which goes far beyond that which has been possible up until now in the production of pipettes or capillaries, in particular those used for patch-clamp experiments. The abovementioned advantages and further advantages will be explained in even more detail hereinbelow.

In the case of the method according to the invention, it is preferred if the glass pipette or glass capillary to be processed is transferred into the retaining device directly from an apparatus for drawing such glass pipettes. This ensures that freshly drawn (freshly pulled) capillaries are (further) processed by the method according to the invention. In some circumstances, it is also advantageously possible, for the purpose of drawing the glass pipettes, to use the same retaining device which is also used for fixing the pipette for the method according to the invention.

As has already been explained, in the case of the method according to the invention, the fixed glass pipette is introduced into the thermal-radiation field of a heating device. The advantageous configuration of the heating device will be explained at a later stage in the text together with the apparatus according to the invention. Express reference is made to what is said in this respect.

In this context, it is, of course, possible to move the heating device relative to the fixed glass pipette. However, since it is preferably possible, in the case of the invention, to observe by optical means the softening or melting operation in the heating device, it is preferred if, rather than the heating device being moved relative to the glass pipette, the glass pipette with the retaining device is moved relative to the heating device. This preferably takes place with the aid of a positioning device, which either is already part of the retaining device or interacts with this retaining device.

In this context, it is, of course, possible for the fixed glass pipette, upon introduction into the thermal-radiation field of the heating device, to be moved in all three directions in space (x-, y-, z-directions). In many cases, however, it is easier for the heating device and the retaining device to have been fixed beforehand in two directions in space (e.g. y- and z-directions) relative to one another, in which case, for the purpose of introducing the fixed glass pipette into the thermal-radiation field, all that is necessary is for the retaining device to be moved, with the aid of the positioning device, in one direction in space (e.g. x-direction). In these cases, the glass pipette is usually secured in the retaining device such that the movement in the x-direction corresponds to a movement in an axial direction (longitudinal direction) of the glass pipette. The movement in the x-direction is, in any case, expedient and usually provided since this movement (capability) also enables the introduction of the pipette into the retaining device and its removal therefrom (exchange).
What has been said above obviously also applies correspondingly to the operation of moving the widened glass pipette out of the thermal-radiation field of the heating device. In order to simplify the control means here, it is obviously preferred if, following the widening operation, the glass pipette is moved back essentially into the starting position, in which it was located prior to being introduced into the thermal-radiation field. The glass pipette can cool there. In order reliably to prevent the pipette from changing its shape further during gradual cooling, the cooling operation can be accelerated, preferably by the pipette having air blown onto it, for example by way of a cooling valve.

As has been explained, the interior of the glass pipette is subjected to a gas pressure in order to initiate the desired widening of the diameter of the pipette. It is preferred here, in principle, if the interior of the pipette is subjected, for this purpose, to a continuous (constant) gas pressure. A proportional valve, for example, may be provided for this purpose. The glass pipette can be subjected to pressure in this way before and/or during the operation of softening/melting it. It is also possible, however, for pressure pulses to be used here, it being possible to vary both the duration of the pressure pulses and the pauses between individual pressure pulses. It is also possible to change the pressure values of individual pressure pulses. All these measures make it possible to conduct the method in a more specific way. For the purposes of the invention, the pressures are usually between 0.1 and 10 bar (10 to 1000 KPa). Pressures in the order of magnitude of 1 bar (100 KPa) are preferred. The gas used is usually air.

As has likewise already been explained, the abrupt widening of the diameter of the glass pipette (and, if appropriate, also the widening and melting operations) is monitored with the aid of an optical observation device. For this purpose, it is possible to select a wide variety of different parameters in respect of the optically imaged shape of the pipette. It is thus possible, in principle, to observe the entire contour line of a glass pipette as the method is conducted. In simplified scenarios, the starting point, or point of origin, for these measurements is expediently, albeit not necessarily, selected to be the (foremost) tip of the cone. At a (fixed) distance from this “zero position”, it is then possible to track at least one diameter of the glass pipette before, during or after the operation of widening the pipette with the gas pressure. It has proven successful, in this context, to observe three diameter values at a fixed distance from the foremost tip of the glass pipette. In a development, it has also proven to be advantageous if a value is determined for the length of the tip between the base surface and top surface of the cone before, during and after the widening operation. The location of the top surface of the cone here coincides with the location of the foremost tip of the cone, and thus with the originating position (zero position). The value for the length of the tip is preferably determined together with at least one diameter at a distance from the foremost tip, preferably together with the abovementioned three diameter values. This provides a total of four measured values for monitoring the geometry of the widened pipette.

As a matter of form, it should also be stated that the method of the whole, as it is conducted in the preferred way described, is determined essentially by three method parameters, namely
temperature of the thermal-radiation field which acts on the fixed glass pipette,
x-position of the fixed glass pipette, and
gas pressure for widening the diameter.

In addition to the method according to the invention, the invention also comprises an apparatus for producing glass pipettes or glass capillaries, the latter being provided, in particular, for patch-clamp experiments, having the following devices:
a retaining device for fixing the glass pipette.
a heating device for softening, in particular melting, regions of the glass pipette with the aid of a thermal-radiation field.
a positioning device for the controlled movement and positioning of the glass pipette, at least in the axial direction thereof, in relation to the heating device. The retaining device here is preferably moved with the aid of this positioning device.
a device for subjecting the interior of the glass pipette to a gas pressure in a defined manner.
an observation device for the optical observation of the glass pipette, in particular of the region of the tip of the glass pipette, as the glass pipette is heated up and as it is subjected to gas pressure.
a control/monitoring device for selecting and influencing the parameters of the method implemented by the apparatus, in particular for influencing the temperature in the heating device, the gas pressure and the movement (in particular in the axial direction of the pipette) of the positioning device.

In order to explain the function of the individual devices of the apparatus according to the invention, reference is made (expressly) to what is said hereinbelow, and also to what has already been said in relation to the method according to the invention. The explanations in respect of the method according to the invention should also expressly form part of the explanations in respect of the apparatus according to the invention, and vice versa.

In the case of preferred embodiments of the apparatus according to the invention, the retaining device is a clamping means for the pipette or capillary. This means that the pipette can easily be fixed in the retaining device and removed from the same again.

In order to avoid pressure losses during the operation of widening the pipette, and to improve the controllability of the way in which the method is conducted, the glass pipette, for the purposes of the invention, can preferably be fixed in a pressure-tight manner in the retaining device.

In order to generate a thermal-radiation field, it is possible to use, in principle, any suitable heating device for generating thermal radiation (IR radiation). This may be in the form, for example, of a gas flame (e.g. acetylene flame) or of an infrared laser. It is preferred, however, if the heating device is a so-called heating filament. Such heating filaments are known to a person skilled in the art.

In a development, for the purposes of the invention, the heating device, in particular the heating filament, is of essentially annular or also U-shaped design, in which case, accordingly, it at least partially encloses the glass pipette around its outer circumference. Such enclosure of the glass pipette for the purpose of generating a radially homogeneous thermal-radiation field can easily be provided by such U-shaped heating devices or heating filaments.

Since the intention is to observe the pipette in particular during the operation of softening the glass in the thermal-radiation field, in particular during partial melting, and during widening by gas pressure, it is advantageous if the heating device allows a free view of the pipette for optical detection purposes. This can be achieved, in particular, by the heating device or the heating filament being positioned obliquely in relation to the longitudinal direction of the glass pipette. This oblique positioning preferably takes place at an angle of approximately 45°.

In a development, the heating device is configured such that the heating output thereof is current-controlled. This means that it is particularly straightforward to alter the thermal-radiation field during the operation of softening the glass pipette.

In the case of the apparatus according to the invention, the device for subjecting the interior of the glass pipette to a gas pressure in a defined manner is preferably designed for subjecting the glass pipette to pressure on a continuous basis. This device preferably has a proportional valve in order to subject the glass pipette to pressure on a continuous basis in a regulateable manner. The associated advantages have already been explained in conjunction with the method according to the invention.

For the optical observation of the glass pipette as the latter is melted and subjected to gas pressure, all possible optical observation devices can be used in principle, for example those using CCD or CMOS technology. The invention preferably uses an observation device which may be referred to as a measuring microscope with a CCD camera. Use is therefore made of a magnifying lens, for example with 10-fold magnification, which is combined with a CCD camera. This camera may be in the form of a gray-scale camera. This observation device is focused on the tip of the pipette, an automatic focusing device expediently being provided.

The control/monitoring device for the apparatus according to the invention preferably comprises an image-processing system, with the aid of which it is possible to track the change in the outer contour of the pipette as the latter is heated up and subjected to pressure. Provision may likewise be made for the corresponding image sequence to be recorded.

Finally, the apparatus according to the invention may also comprise a device for drawing glass pipettes or glass capillaries. This makes it possible for freshly drawn pipettes or capillaries to be introduced directly into the apparatus according to the invention.

Further features of the invention can be gathered from the following description of preferred embodiments in conjunction with the subclaims. It is possible here for the individual features to be realized in each case on their own or in combination with one another. The embodiments described serve merely for explanatory purposes and to give a better understanding of the invention and are not to be understood as being in any way restrictive.

In the drawings:

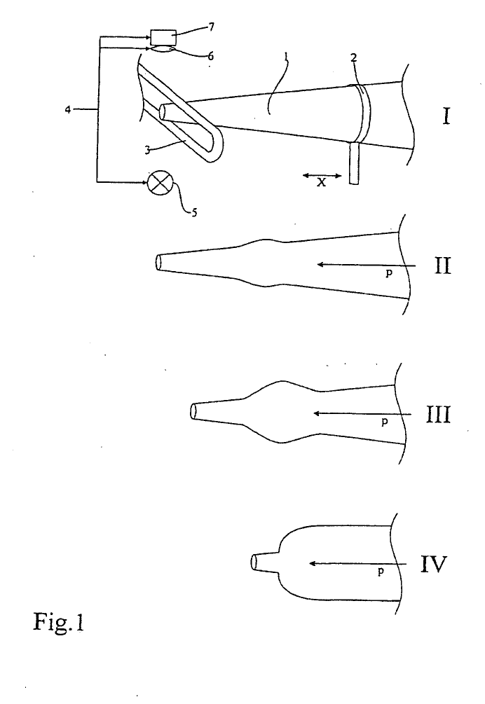

FIG. 1 shows a schematic diagram for the purpose of explaining the method according to the invention and the apparatus according to the invention, and

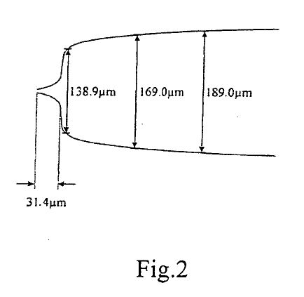

FIG. 2 shows a schematic illustration of a pipette or capillary which can be produced by the method according to the invention and the apparatus according to the invention.

The schematic diagram according to FIG. 1 shows, on the one hand, a number of essential constituent parts of the apparatus according to the invention and, on the other hand, a rough sequence followed by the method according to the invention.

Thus, FIG. 1 illustrates a glass pipette or glass capillary 1 which is fixed in a retaining device 2 (clamping means). The retaining device 2 is provided with a positioning device (not illustrated), with the aid of which the capillary 1 fixed in the retaining device 2 can be moved in the x-direction, i.e. in the axial direction of the capillary 1.

FIG. 1 also shows a heating device 3 in the form of a U-shaped heating filament which can generate a radially homogeneous thermal-radiation field for softening or melting the capillary 1.

Also provided in FIG. 1 is an observation device 4 which comprises a lamp 5, microscope optics 6 and a CCD camera 7. This moveable observation device 4 makes it possible to observe the pipette 1 during the softening/melting operation and as the pipette is subjected to gas pressure. In order for this observation to be ensured, the heating filament is positioned obliquely by approximately 45° in relation to the observation direction.

Other details of an apparatus according to the invention have not been illustrated in FIG. 1, in particular the device for subjecting the interior of the glass pipette to a gas pressure in a defined manner and any control and monitoring devices which may be present.

The sequence followed by the method according to the invention is likewise indicated schematically in FIG. 1, the latter showing the shape and approximate position of the capillary 1 in method stages I, II, III and IV.

Thus, in method stage I, the capillary 1 fixed in the retaining device 2 is moved into the thermal-radiation field of the heating device 3 in the x-direction, in which case the (first) capillary section to be widened ends up located in the thermal-radiation field. This first section is preferably that which (in respect of the capillary) as the method is conducted, is furthest away from the tip of the capillary.

As soon as that (first) section of the capillary which is to be widened is located in the thermal-radiation field, the interior of the capillary is subjected to a constant gas pressure of approximately 1 bar. It is also possible, in principle, to introduce into the thermal-radiation field a capillary which is already subjected to the gas pressure.

As is schematically shown in method stage II in FIG. 1, the softened/melted first capillary section is widened by the gas pressure. As soon as this has taken place (to the desired extent) under the optical monitoring envisaged according to the invention, corresponding movement of the capillary in the x-direction moves the next (second) capillary section into the thermal-radiation field. This next (second) capillary section is closer to the tip of the capillaries than the first, already widened capillary section. As soon as the glass of the capillary has also been softened or melted on the second capillary section, it is likewise the case here that the continuously prevailing gas pressure causes corresponding widening, which is likewise once again monitored optically. This is illustrated schematically in method stage III in FIG. 1.

In the present case, for the purposes of the invention, the procedure is such that the gas pressure is kept constant for the entire duration over which the method is conducted. In this case, for the selected procedure in which widening takes place section by section in the direction of the tip of the capillary, it is possible to vary the energy content of the thermal-radiation field (e.g. by controlling the current of the heating filament used). It is usually the case here that the closer the section to the tip of the capillary, the lower are the energy-content/heating output levels used. This is due to the fact that the wall thickness of the glass capillary usually decreases in the direction of the tip.

The same result could also be achieved, however, by the energy content/heating output being kept constant for the duration of the method and by the gas pressure being reduced correspondingly as proximity to the tip of the capillary increases.

Method stage IV in FIG. 1 illustrates a fourth and final method step, in which the region of the tip of the capillary itself is widened. For this purpose, that capillary section which is closest to the tip, or comprises said tip, is introduced into the thermal-radiation field, by movement in the x-direction, and widened by the constant gas pressure which still prevails. This then gives the final characteristic shape of the pipette/capillary with the abrupt widening of the diameter from the base surface of the remaining conical tip to the essentially tubular section of the pipette/capillary.

Finally, and this is not illustrated in FIG. 1, the pipette which has been widened in the desired manner is moved all the way out of the thermal-radiation field in the x-direction, or this thermal-radiation field is deactivated. The finished pipette is then usually gradually air-cooled. This cooling operation may be accelerated, in addition, by the pipette having cold air blown onto it using a means which is not illustrated.

FIG. 2 shows the shape and the dimensions of an exemplary glass pipette or glass capillary as can be attained using the method according to the invention and the apparatus according to the invention. A characteristic feature is the abrupt widening of the diameter of the capillary between the region of the conical tip and the essentially tubular section of the capillary which adjoins this tip.

FIG. 2 also shows, as has been described in the description, four values as determined for monitoring and controlling the abrupt widening of the diameter during production of such pipettes or capillaries using the method according to the invention. As has been described, the originating position (zero position) is selected to be at the (foremost) tip of the cone. The four values determined are then, first of all, the length of the tip between the zero position/originating position (at the top surface of the cone) and the base surface of cone. Furthermore, the diameter values in the tubular section are determined at three (predetermined) locations.

In the present case, the length of the tip is 31.4 μm. The three diameter values in the tubular section are 138.9 μm, 169.0 μm and 189.0 μm. Of course, these values are merely examples and, as such, cannot restrict in any way the subject matter of the present invention.

1. A method of producing glass pipettes or glass capillaries, in particular for patch-clamp experiments, wherein p1 at least one glass pipette or glass capillary (1), which has a conical tip and an essentially tubular section adjoining the tip, is fixed in a retaining device (2),
the fixed glass pipette (1) is introduced into the thermal-radiation field of a heating device (3), it preferably being the case that the fixed glass pipette is moved into the thermal-radiation field of the heating device with the aid of a positioning device,
the glass pipette is softened, preferably melted, at least in the region of the tip, in particular in the region of the base surface of the cone and, if appropriate, also in that part of the tubular section which adjoins the tip, the softening operation preferably taking place in sections,
prior to the softening operation and/or in the softened state, the interior of the glass pipette (1) is subjected to a gas pressure such that the diameter of the pipette between the base surface of the cone and the tubular section of the glass pipette widens abruptly, i.e. over a short length, to a larger diameter than that at the base surface, in particular to a diameter of at least 100 μm, it being the case that
the glass pipette (1) widened in this way is removed from the thermal-radiation field of the heating device (3), the glass pipette preferably being moved out of the thermal-radiation field with the aid of the positioning device,
the abrupt widening of the diameter of the glass pipette (1) is monitored and preferably controlled with the aid of an optical observation device (4).

2. The method as claimed in claim 1, characterized in that the glass pipette is transferred into the retaining device directly from an apparatus for drawing such glass pipettes.

3. The method as claimed in claim 1 or 2, characterized in that, upon introduction and upon removal from the thermal-radiation field, the fixed glass pipette is moved essentially only axially, i.e. in its longitudinal direction, with the aid of the positioning device.

4. The method as claimed in one of the preceding claims, characterized in that, following the softening operation in the thermal-radiation field, the glass pipette is moved back essentially into the starting position, in which it was located prior to being introduced into the thermal-radiation field.

5. The method as claimed in one of the preceding claims, characterized in that a continuous gas pressure is built up in the interior of the glass pipette.

6. The method as claimed in one of the preceding claims, characterized in that various longitudinal sections of the glass pipette are introduced one after the other into the thermal-radiation field and are widened there by being subjected to gas pressure, it preferably being the case that the length of the resulting widened contour of the glass pipette in the axial direction of the latter is greater than the extent of the thermal-radiation field in this axial direction.

7. The method as claimed in one of the preceding claims, characterized in that, in order to monitor and control the abrupt widening of the diameter, the change in the outer contour of the glass pipette is observed, the values preferably being determined for the change in dimensions of the glass pipette at predefined locations.

8. The method as claimed in claim 7, characterized in that values are determined for at least one diameter of the glass pipette, preferably three diameters, at a fixed distance from the tip of the glass pipette.

9. The method as claimed in claim 7 or claim 8, characterized in that the value is determined for the length of the tip between the base surface and top surface of the cone.

10. An apparatus for producing glass pipettes or glass capillaries (1), in particular for patch-clamp experiments, having
a retaining device (2) for fixing the glass pipette (1),
a heating device (3) for softening, in particular melting, regions of the glass pipette with the aid of a thermal-radiation field,
a positioning device for the controlled movement and positioning of the glass pipette, at least in the axial direction thereof, in relation to the heating device, it preferably being possible for the retaining device to be moved with the aid of this positioning device,
a device for subjecting the interior of the glass pipette to a gas pressure in a defined manner,
an observation device (4) for the optical observation of the glass pipette, in particular of the region of the tip of the glass pipette, as the glass pipette is heated up and subjected to gas pressure, and
a control/monitoring device for selecting and influencing the parameters of the method implemented by the apparatus, in particular for influencing the temperature in the heating device, the gas pressure and the movement of the positioning device.

11. The apparatus as claimed in claim 10, characterized in that the retaining device (2) is a clamping means.

12. The apparatus as claimed in claim 10 or claim 11, characterized in that the glass pipette can be fixed in a pressure-tight manner in the retaining device.

13. The apparatus as claimed in one of claims 10 to 12, characterized in that the heating device (3) is a so-called heating filament.

14. The apparatus as claimed in one of claims 10 to 13, characterized in that the heating device (3), in particular the heating filament, is of U-shaped design and, accordingly, at least partially encloses the glass pipette around its outer circumference.

15. The apparatus as claimed in one of claims 10 to 14, characterized in that the heating device (3), in particular the heating filament, is positioned obliquely in relation to the longitudinal direction of the glass pipette, preferably at an angle of approximately 45°.

16. The apparatus as claimed in one of claims 10 to 15, characterized in that the heating output of the heating device is current-controlled.

17. The apparatus as claimed in one of claims 10 to 16, characterized in that the device for subjecting the interior of the glass pipette to a gas pressure in a defined manner is designed for subjecting the glass pipette to pressure on a continuous basis.

18. The apparatus as claimed in one of claims 10 to 17, characterized in that the observation device is a measuring microscope (6) with a CCD camera (7).

19. The apparatus as claimed in one of claims 10 to 18, characterized in that the control/monitoring device comprises an image-processing system, with the aid of which it is possible to track the change in the outer contour of the glass pipette as the latter is heated up and subjected to pressure.

20. The apparatus as claimed in one of claims 10 to 19, further characterized by a device for drawing glass pipettes or glass capillaries.
